(19) United States
(12) Patent Application Publication
(10) Pub. No.: US 2023/0393059 A1
(43) Pub. Date: Dec. 7, 2023

(54) DATA PROCESSING APPARATUS, DATA PROCESSING METHOD, DATA PROCESSING PROGRAM, OPTICAL ELEMENT, IMAGING OPTICAL SYSTEM, AND IMAGING APPARATUS

(71) Applicant: FUJIFILM Corporation, Tokyo (JP)

(72) Inventors: Atsushi KAWANAGO, Saitama (JP); Yasunobu KISHINE, Saitama (JP); Kazuyoshi OKADA, Saitama (JP); Yuya HIRAKAWA, Saitama (JP)

(73) Assignee: FUJIFILM Corporation, Tokyo (JP)

(21) Appl. No.: 18/453,300

(22) Filed: Aug. 21, 2023

Related U.S. Application Data
(63) Continuation of application No. PCT/JP2022/007789, filed on Feb. 25, 2022.

(30) Foreign Application Priority Data
Feb. 26, 2021 (JP) 2021-030058

(51) Int. Cl. G01N 21/31; G06V 10/58; G06V 10/94

(52) U.S. Cl. CPC G01N 21/31; G06V 10/58; G06V 10/945; G01N 2021/3129; H04N 23/10

(57) ABSTRACT

Provided are a data processing apparatus, a data processing method, a data processing program, an optical element, an imaging optical system, and an imaging apparatus which can select two or more wavelengths suitable for discrimination of a desired subject among a plurality of subjects. In a data processing apparatus (10-1) including a processor, the processor performs data acquisition processing of acquiring first spectral data of a first subject and second spectral data of a second subject, and wavelength selection processing of selecting a plurality of specific wavelengths from wavelength ranges of the acquired first spectral data and second spectral data, and in the wavelength selection processing, the plurality of specific wavelengths are selected based on a difference in a feature amount between the first spectral data and the second spectral data.

### CROSS-REFERENCE TO RELATED APPLICATIONS

The present application is a Continuation of PCT International Application No. PCT/JP2022/007789 filed on Feb. 25, 2022 claiming priority under 35 U.S.C. § 119(a) to Japanese Patent Application No. 2021-030058 filed on Feb. 26, 2021. Each of the above applications is hereby expressly incorporated by reference, in its entirety, into the present application.

### BACKGROUND OF THE INVENTION

### 1. Field of the Invention

The present invention relates to a data processing apparatus, a data processing method, a data processing program, an optical element, an imaging optical system, and an imaging apparatus, particularly, relates to the technology of selecting two or more wavelengths suitable for discrimination of a desired subject among a plurality of subjects.

### 2. Description of the Related Art

In the related art, there is a hyperspectral camera capable of executing spectral sensing using a wavelength of 100 or more.

In this type of hyperspectral camera, since many wavelengths are measured, it is common to sense a detection object by searching for a wavelength at which reflection or absorption is abruptly changed.

JP2019-40155A discloses a bandpass filter design system that searches for a design condition of a bandpass filter disposed in an imaging optical system in an imaging apparatus.

This bandpass filter design system inputs detection algorithm information of spectral data necessary for discriminating a target event from a subject, an imaging condition in a case in which the subject is imaged by an imaging apparatus, imaging element information related to an imaging element, and the like, and searches for a design condition of the bandpass filter based on these types of information by using artificial intelligence, for example.

It should be noted that the detection algorithm information is an algorithm for detecting spectral data necessary for actually imaging the subject with the imaging apparatus and determining the target event.

### SUMMARY OF THE INVENTION

One embodiment according to the technology of the present disclosure provides a data processing apparatus, a data processing method, a data processing program, an optical element, an imaging optical system, and an imaging apparatus which can select two or more wavelengths suitable for discrimination of a desired subject among a plurality of subjects.

A first aspect of the present invention relates to a data processing apparatus comprising a processor, in which the processor performs data acquisition processing of acquiring first spectral data of a first subject and second spectral data of a second subject, and wavelength selection processing of selecting a plurality of specific wavelengths from wavelength ranges of the acquired first spectral data and second spectral data, and in the wavelength selection processing, the plurality of specific wavelengths are selected based on a difference in a feature amount between the first spectral data and the second spectral data.

In the data processing apparatus according to a second aspect of the present invention, it is preferable that the feature amount is spectral reflectance or spectral intensity.

In the data processing apparatus according to a third aspect of the present invention, it is preferable that at least one specific wavelength among the plurality of specific wavelengths is a wavelength at which the difference in the feature amount is largest.

In the data processing apparatus according to a fourth aspect of the present invention, it is preferable that, in the data acquisition processing, data is acquired from a device that acquires two-dimensional spectrum data of wavelengths more than the selected plurality of specific wavelengths.

In the data processing apparatus according to a fifth aspect of the present invention, it is preferable that the processor performs display processing of displaying a visible image showing the spectrum data on a display based on the spectrum data.

In the data processing apparatus according to a sixth aspect of the present invention, it is preferable that, in the data acquisition processing, a first region of the first subject and a second region of the second subject are specified on the display based on a user indication, and the first spectral data and the second spectral data in the first region and the second region are acquired.

In the data processing apparatus according to a seventh aspect of the present invention, it is preferable that, in the data acquisition processing, representative values of the feature amounts in the first region and the second region are calculated to acquire the first spectral data and the second spectral data.

In the data processing apparatus according to an eighth aspect of the present invention, it is preferable that the representative value is an average value, a median value, or a most frequent value.

In the data processing apparatus according to a ninth aspect of the present invention, it is preferable that, in the wavelength selection processing, a first wavelength at which the difference in the feature amount between the first spectral data and the second spectral data is largest, and a second wavelength at which the difference in the feature amount between the first spectral data and the second spectral data is largest or maximum in a different wavelength range separated from the first wavelength by a wavelength difference equal to or larger than a predetermined difference are selected as the specific wavelengths.

In the data processing apparatus according to a tenth aspect of the present invention, it is preferable that the predetermined difference is equal to or larger than 5 nm.

In the data processing apparatus according to an eleventh aspect of the present invention, it is preferable that, in the wavelength selection processing, in a case in which a reference wavelength at which the feature amounts of the acquired first spectral data and second spectral data match each other is present, a third wavelength at which the difference in the feature amount between the first spectral data and the second spectral data is largest on a short wave side with respect to the reference wavelength, and a fourth wavelength at which the difference in the feature amount between the first spectral data and the second spectral data is largest on a long wave side with respect to the reference wavelength are selected as the specific wavelengths.

In the data processing apparatus according to a twelfth aspect of the present invention, it is preferable that, in the wavelength selection processing, in a case in which two or more reference wavelengths at which the feature amounts of the acquired first spectral data and second spectral data match each other are present, a fifth wavelength at which the difference in the feature amount between the first spectral data and the second spectral data is largest between the two or more reference wavelengths is selected as one of the plurality of specific wavelengths.

In the data processing apparatus according to a thirteenth aspect of the present invention, it is preferable that the wavelength selection processing includes processing of displaying a first graph and a second graph showing the acquired first spectral data and second spectral data on a display in a discriminable manner, and processing of receiving a plurality of wavelengths indicated by a user in relation to the first graph and the second graph, which are displayed on the display, as the plurality of specific wavelengths.

A fourteenth aspect of the present invention relates to an optical element comprising a plurality of wavelength selection elements, in which the plurality of wavelength selection elements transmit wavelength ranges of the plurality of specific wavelengths selected by the data processing apparatus according to any one of the first to thirteenth aspects.

A fifteenth aspect of the present invention relates to an imaging optical system comprising the optical element according to the fourteenth aspect that is disposed at a pupil position or in a vicinity of the pupil position.

A sixteenth aspect of the present invention relates to an imaging apparatus comprising the imaging optical system according to the fifteenth aspect, and an imaging element that captures a plurality of optical images which are image-formed by the imaging optical system and are transmitted through the plurality of wavelength selection elements, respectively.

A seventeenth aspect of the present invention relates to a data processing method comprising a data acquisition step of acquiring first spectral data of a first subject and second spectral data of a second subject, and a wavelength selection step of selecting a plurality of specific wavelengths from wavelength ranges of the acquired first spectral data and second spectral data, in which the plurality of specific wavelengths are selected based on a difference in a feature amount between the first spectral data and the second spectral data, in which a processor executes processing of each step.

In the data processing method according to an eighteenth aspect of the present invention, it is preferable that the feature amount is spectral reflectance or spectral intensity.

In the data processing method according to a nineteenth aspect of the present invention, it is preferable that at least one specific wavelength among the plurality of specific wavelengths is a wavelength at which the difference in the feature amount is largest.

In the data processing method according to a twentieth aspect of the present invention, it is preferable that, in the data acquisition step, data is acquired from a device that acquires spectrum data of wavelengths more than the selected plurality of specific wavelengths.

It is preferable that the data processing method according to a twenty-first aspect of the present invention further comprising a step of displaying a visible image showing the spectrum data on a display based on the spectrum data.

In the data processing method according to a twenty-second aspect of the present invention, it is preferable that, in the data acquisition step, a first region of the first subject and a second region of the second subject are specified on the display based on a user indication, and the first spectral data and the second spectral data in the first region and the second region are acquired.

In the data processing method according to a twenty-third aspect of the present invention, it is preferable that, in the data acquisition step, representative values of the feature amounts in the first region and the second region are calculated to acquire the first spectral data and the second spectral data.

In the data processing method according to a twenty-fourth aspect of the present invention, it is preferable that the representative value is an average value, a median value, or a most frequent value.

In the data processing method according to a twenty-fifth aspect of the present invention, it is preferable that, in the wavelength selection step, a first wavelength at which the difference in the feature amount between the first spectral data and the second spectral data is largest, and a second wavelength at which the difference in the feature amount between the first spectral data and the second spectral data is largest or maximum in a different wavelength range separated from the first wavelength by a wavelength difference equal to or larger than a predetermined difference are selected as the specific wavelengths, respectively.

In the data processing method according to a twenty-sixth aspect of the present invention, it is preferable that the predetermined difference is equal to or larger than 5 nm.

In the data processing method according to a twenty-seventh aspect of the present invention, it is preferable that, in the wavelength selection step, in a case in which a reference wavelength at which the feature amounts of the acquired first spectral data and second spectral data match each other is present, a third wavelength at which the difference in the feature amount between the first spectral data and the second spectral data is largest on a short wave side with respect to the reference wavelength, and a fourth wavelength at which the difference in the feature amount between the first spectral data and the second spectral data is largest on a long wave side with respect to the reference wavelength are selected as the specific wavelengths, respectively.

In the data processing method according to a twenty-eighth aspect of the present invention, it is preferable that, in the wavelength selection step, in a case in which two or more reference wavelengths at which the feature amounts of the acquired first spectral data and second spectral data match each other are present, a fifth wavelength at which the difference in the feature amount between the first spectral data and the second spectral data is largest between the two or more reference wavelengths is selected as one of the plurality of specific wavelengths.

In the data processing method according to a twenty-ninth aspect of the present invention, it is preferable that the wavelength selection step includes a step of displaying a first graph and a second graph showing the acquired first spectral data and second spectral data on a display in a discriminable manner, and a step of receiving a plurality of wavelengths indicated by a user in relation to the first graph and the second graph, which are displayed on the display, as the plurality of specific wavelengths.

A thirtieth aspect of the present invention relates to a data processing program causing a computer to realize a function of acquiring first spectral data of a first subject and second spectral data of a second subject, and a function of selecting a plurality of specific wavelengths from wavelength ranges of the acquired first spectral data and second spectral data, in which the plurality of specific wavelengths are selected based on a difference in a feature amount between the first spectral data and the second spectral data.

### BRIEF DESCRIPTION OF THE DRAWINGS

FIG. 1 is a schematic diagram showing a first example in which two subjects to be classified are simultaneously imaged to acquire spectral information of each subject.

FIG. 2 is a diagram showing an example of a state in which a data cube is created from the spectral information acquired by a hyperspectral camera.

FIGS. 3A and 3B are schematic diagrams showing a second example in which the two subjects to be classified are individually imaged to acquire the spectral information of each subject.

FIG. 4 is a diagram showing another example of a state in which the data cube is created from the spectral information acquired by the hyperspectral camera.

FIG. 5 is a diagram showing a first example of a visible image that can be created from the data cube including a first subject and a second subject.

FIG. 6 is a graph showing first spectral data of the first subject and second spectral data of the second subject.

FIG. 7 is a diagram showing a second example of the visible image that can be created from the data cube including one first subject and two second subjects.

FIG. 8 is a graph showing the first spectral data of the one first subject and two second spectral data of the two second subjects of the same type.

FIG. 9 is a diagram showing a third example of the visible image that can be created from the data cube including the first subject, the second subject, and a third subject.

FIG. 10 is a graph showing the first spectral data of the first subject, the second spectral data of the second subject, and third spectral data of the third subject.

FIG. 11 is a functional block diagram showing a first embodiment of a data processing apparatus according to the embodiment of the present invention.

FIG. 12 is a graph showing a first example of first spectral data A(λ) and second spectral data B(λ).

FIG. 13 is a graph showing a second example of the first spectral data A(λ) and the second spectral data B(λ).

FIG. 14 is a graph showing a third example of the first spectral data A(λ) and the second spectral data B(λ).

FIG. 15 is a graph showing a fourth example of the first spectral data A(λ) and the second spectral data B(λ).

FIG. 16 is a graph showing a fifth example of the first spectral data A(λ) and the second spectral data B(λ).

FIG. 17 is a functional block diagram showing a second embodiment of the data processing apparatus according to the embodiment of the present invention.

FIG. 18 is a schematic diagram showing an example of the multispectral camera.

FIG. 19 is a flowchart showing an embodiment of a data processing method according to the embodiment of the present invention.

FIG. 20 is a sub-routine showing an embodiment of a processing procedure in step S10 shown in FIG. 19.

FIG. 21 is a sub-routine showing a first embodiment of a processing procedure in step S20 shown in FIG. 19.

FIG. 22 is a sub-routine showing a second embodiment of the processing procedure in step S20 shown in FIG. 19.

### DESCRIPTION OF THE PREFERRED EMBODIMENTS

Hereinafter, preferred embodiments of a data processing apparatus, a data processing method, and a data processing program, an optical element, an imaging optical system, and an imaging apparatus according to the embodiment of the present invention will be described with reference to the accompanying drawings.

### First Example of Acquisition of Spectral Information

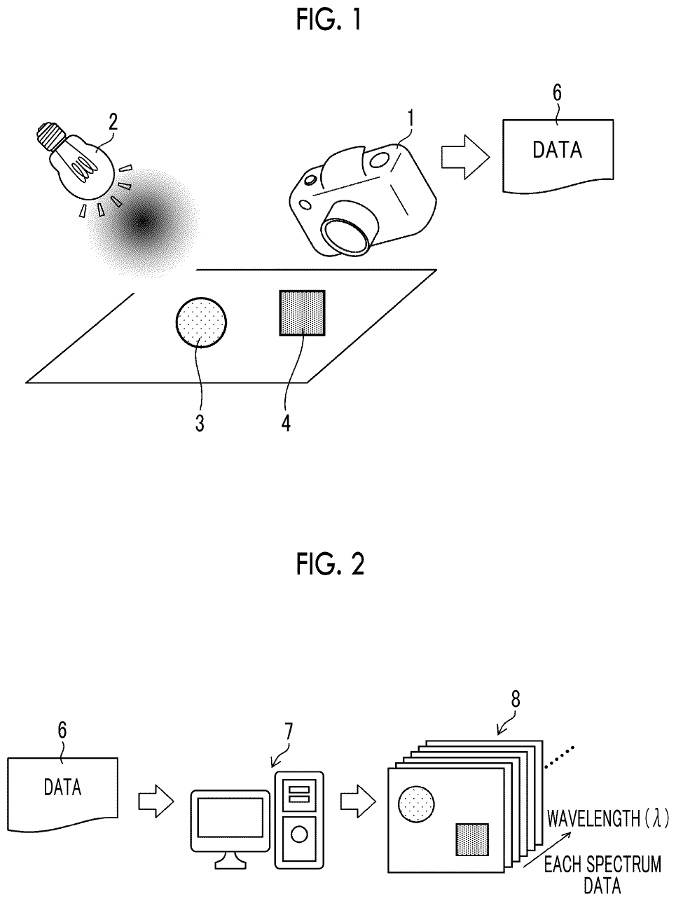

FIG. 1 is a schematic diagram showing a first example in which two subjects to be classified are simultaneously imaged to acquire spectral information of each subject.

In the first example shown in FIG. 1, subjects of different types (first subject 3 and second subject 4) to be classified are simultaneously imaged by a hyperspectral camera 1.

The hyperspectral camera 1 is a camera that images light, which is emitted by the light source 2 and reflected by the first subject 3 and the second subject 4, in a spectral manner for each wavelength, and acquires spectral information 6 of a plurality of wavelengths. Since the first subject 3 and the second subject 4 to be classified are mixed, it is possible to acquire the spectral information 6 including an influence (such as secondary reflected light) on each other.

As shown in FIG. 2, the spectral information 6 is input to a computer 7 in which data processing software of the hyperspectral camera 1 is installed, and is subjected to data processing here to be converted into data called a data cube 8.

The data cube 8 is data having a three-dimensional structure in which two-dimensional spectrum data indicating spectral reflectance or spectral intensity is arranged for each wavelength (λ) to form a layer.

It should be noted that, as the hyperspectral camera 1, a snapshot type or a push bloom type (line scanning type) can be applied. The snapshot type hyperspectral camera can simultaneously image a certain region with a two-dimensional image sensor, is excellent in real-time performance, and can perform the imaging even a case in which the subject is a moving object. Since the line scanning type hyperspectral camera performs the imaging by moving the subject, it takes a certain amount of time for the imaging, and it is difficult to perform the imaging in a case in which the subject is the moving object. However, it is possible to acquire a large amount of the spectrum data (for example, the spectrum data of 100 to 200 bands) as compared with the snapshot type.

Moreover, the spectrum data acquired by the hyperspectral camera or the like need only be the spectrum data of wavelengths more than the number of specific wavelengths described below, and may be acquired from a device other than the hyperspectral camera (for example, a multispectral camera or the like).

### Second Example of Acquisition of Spectral Information

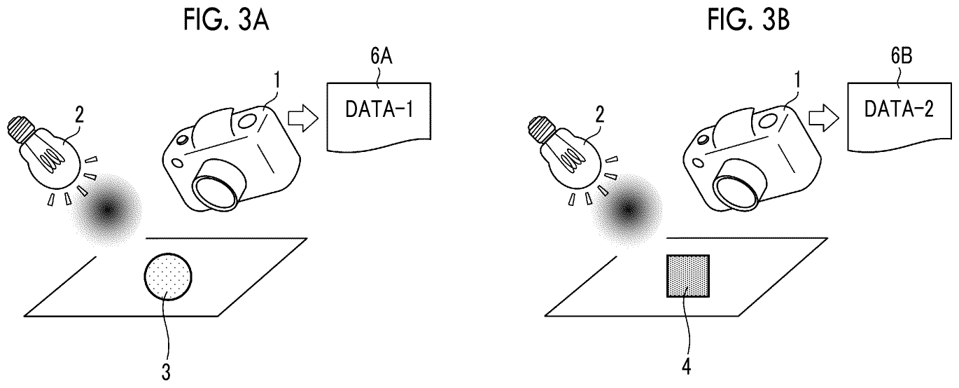

FIGS. 3A and 3B are schematic diagrams showing a second example in which the two subjects to be classified are individually imaged to acquire the spectral information of each subject.

In the second example shown in FIGS. 3A and 3B, the first subject 3 and the second subject 4 are individually imaged by the hyperspectral camera 1.

The hyperspectral camera 1 captures the first subject 3 illuminated by the light source 2 to acquire spectral information 6A of a plurality of wavelengths, and similarly captures the second subject 4 illuminated by the light source 2 to acquire spectral information 6B of a plurality of wavelengths. Since the spectral information 6A and 6B of the first subject 3 and the second subject 4 to be classified can be acquired at different timings, each of the spectral information 6A and 6B can be acquired even in an environment in which the first subject 3 and the second subject 4 cannot be mixed at present.

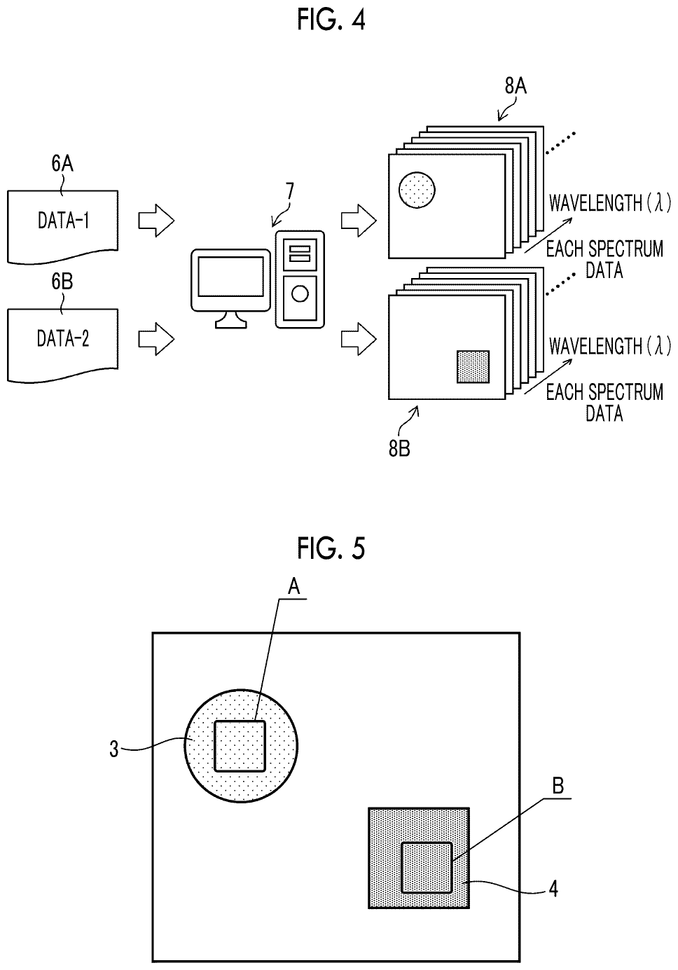

The spectral information 6A and 6B are input to the computer 7 as shown in FIG. 4, respectively, and are subjected to data processing here to be converted into data cubes 8A and 8B.

It should be noted that, since the hyperspectral camera 1 may be provided with a function of the computer 7, it is possible to directly acquire the data cube from the hyperspectral camera 1.

<Acquisition of Spectral Data>

FIG. 5 is a diagram showing a first example of a visible image that can be created from the data cube including a first subject and a second subject.

A user designates a desired region A (first region) of the first subject 3 and a desired region B (second region) of the second subject 4 on the visible image shown in FIG. 5, respectively. In FIG. 5, the desired regions A and B are shown as rectangles.

By using information of the data cube 8 shown in FIG. 2, a representative value of the spectrum data of the region A of the first subject 3 designated by the user is calculated for each wavelength (λ) in the data cube 8.

The representative value of the spectrum data of the region A of the first subject 3 can be, for example, an average value, a median value, or a most frequent value of the spectrum data of the region A of the first subject 3 in the two-dimensional spectrum data corresponding to a certain wavelength.

Similarly, by using the information of the data cube 8 shown in FIG. 2, a representative value of the spectrum data of the region B of the second subject 4 designated by the user is calculated for each wavelength (λ).

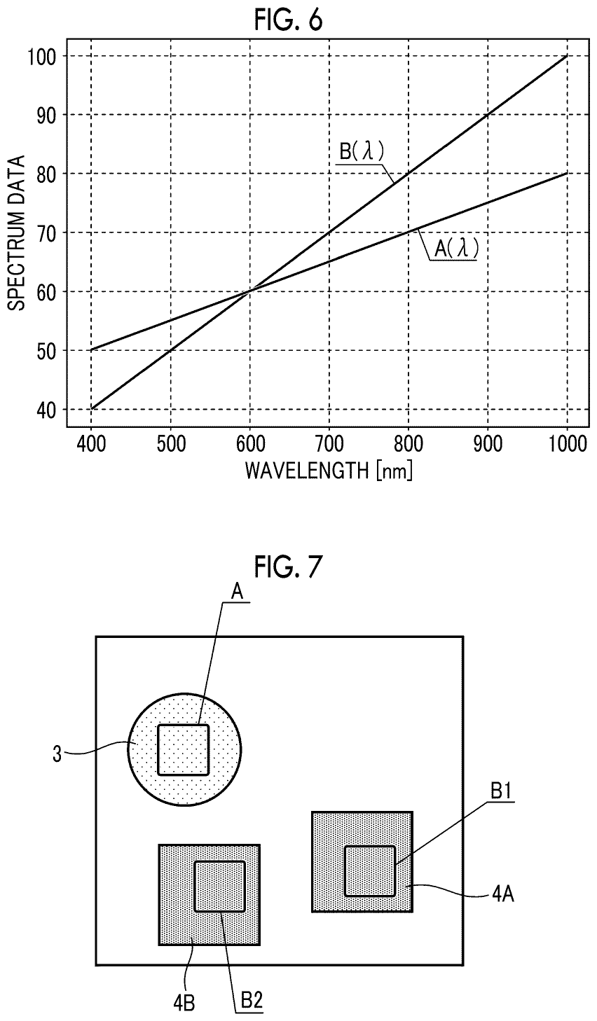

FIG. 6 is a graph showing first spectral data of the first subject and second spectral data of the second subject.

In FIG. 6, a horizontal axis indicates the wavelength (nm), and a vertical axis indicates the spectrum data.

The two-dimensional spectrum data for each wavelength (λ) calculated from the data cube 8 is a discrete value. In a case in which the number of the spectrum data for each wavelength (λ) is small, it is preferable that the number of data is increased by performing linear interpolation, spline interpolation, or the like on the discrete spectrum data to acquire first spectral data A(λ) and second spectral data B(λ) shown in FIG. 6.

In this way, the first spectral data A(λ) of the first subject 3 and the second spectral data B(λ) of the second subject 4 can be acquired.

FIG. 7 is a diagram showing a second example of the visible image that can be created from the data cube including one first subject and two second subjects.

Two second subjects 4A and 4B shown in FIG. 7 are the same subject. That is, a plurality of (two points) subjects are included for each type.

In a case in which the data cube is acquired by the snapshot type hyperspectral camera or the like, the two second subjects 4A and 4B have different disposition positions, and thus imaging conditions are different. That is, illumination conditions by the light source, imaging positions in an imaging range, and the like are different.

In this case, the user designates the region A of the first subject 3 and regions B1 and B2 of the second subjects 4A and 4B on the visible image shown in FIG. 7, respectively.

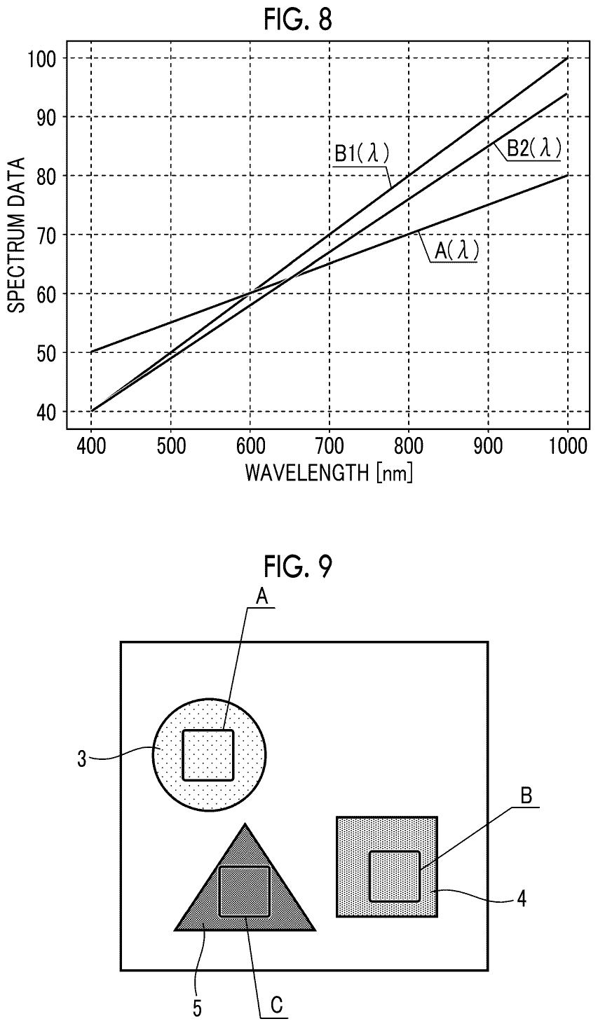

FIG. 8 is a graph showing the first spectral data of the one first subject and two second spectral data of the two second subjects of the same type.

In the same manner as described above, as shown in FIG. 8, the first spectral data A(λ) of the first subject 3 and the second spectral data B1(λ) and B2(λ) of the two second subjects 4A and 4B can be acquired.

FIG. 9 is a diagram showing a third example of the visible image that can be created from the data cube including the first subject, the second subject, and a third subject.

The first subject 3, the second subject 4, and a third subject 5 shown in FIG. 9 are subjects of different types to be classified, respectively.

On the visible image shown in FIG. 9, the user designates the region A of the first subject 3, the region B of the second subject 4, and a region C of the third subject 5, respectively.

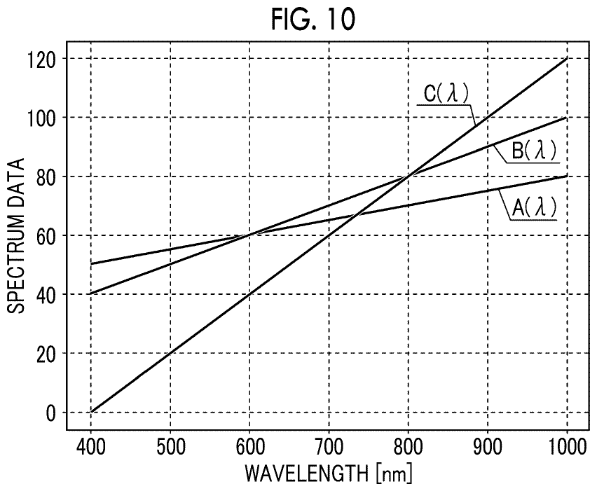

FIG. 10 is a graph showing the first spectral data of the first subject, the second spectral data of the second subject, and third spectral data of the third subject.

In the same manner as described above, as shown in FIG. 10, the first spectral data A(λ) of the first subject 3, the second spectral data B(λ) of the second subject 4, and third spectral data C(λ) of the third subject 5 can be acquired.

### First Embodiment of Data Processing Apparatus

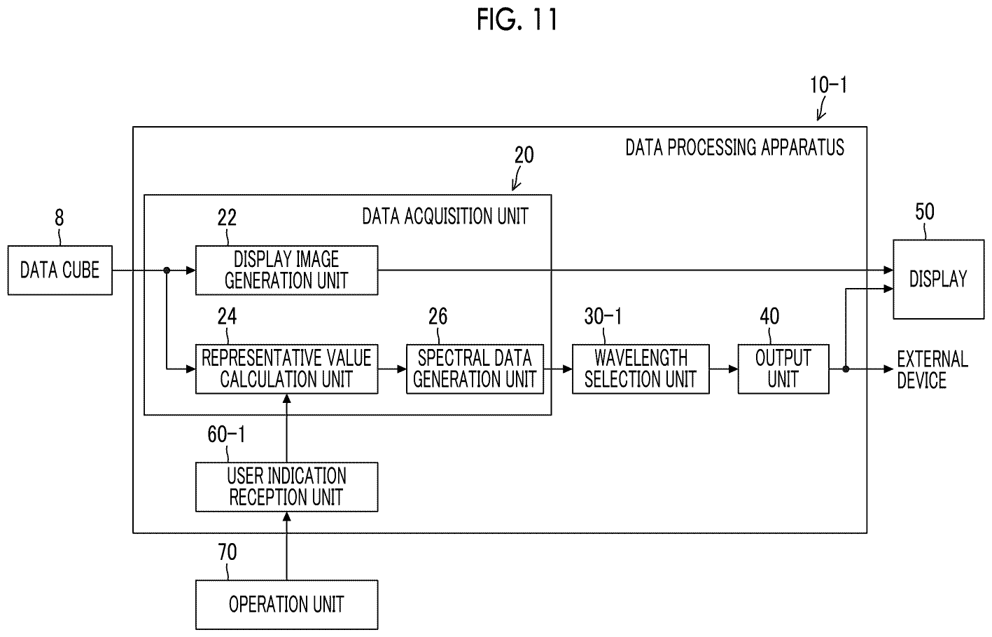

FIG. 11 is a functional block diagram showing a first embodiment of the data processing apparatus according to the embodiment of the present invention.

A data processing apparatus 10-1 according to the first embodiment can be configured by a personal computer, a workstation, or the like comprising hardware, such as a processor, a memory, and an input/output interface.

The processor is composed of a central processing unit (CPU) or the like, controls each unit of the data processing apparatus 10-1 in an integrated manner, and can function as a data acquisition unit 20, an output unit 40, and a user indication reception unit 60-1 shown in FIG. 11, for example.

The data processing apparatus 10-1 according to the first embodiment shown in FIG. 11 automatically selects two or more wavelengths suitable for separating the first subject 3 and the second subject 4 of different types shown in FIG. 1, and comprises, for example, the data acquisition unit 20, the output unit 40, and the user indication reception unit 60-1.

The data acquisition unit 20 is a unit that performs data acquisition processing of acquiring the first spectral data of the first subject and the second spectral data of the second subject, and comprises a display image generation unit 22, a representative value calculation unit 24, and a spectral data generation unit 26.

For example, the data cube 8 shown in FIG. 2 is input to each of the display image generation unit 22 and the representative value calculation unit 24, respectively.

The display image generation unit 22 is a unit that creates the visible image (display image) that visualizes the specification of the first subject 3 and the second subject 4 from the data cube 8, and performs display processing of displaying the display image on a display 50.

The display image can be, for example, a pseudo-color image of blue (B), green (G), or red (R) from the spectrum data of the bands corresponding to R, G, and B included in the data cube 8. It should be noted that the display image is not limited to the pseudo-color image, may be a monochrome image. In short, the display image need only be an image in which the first subject 3 and the second subject 4 can be specified.

The display image generated by the display image generation unit 22 is output to the display 50, and is displayed as an image showing the first subject 3 and the second subject 4 here. The image shown in FIG. 5 is an example of an image displayed on the display 50.

The user indication reception unit 60-1 is a unit that receives the region A of the first subject 3 and the region B of the second subject 4 which are specified on the display 50 according to the user indication. That is, via a user interface consisting of the display 50 and an operation unit 70 of a pointing device, such as a mouse, the user indication reception unit 60-1 receives information indicating the region A of the first subject 3 and the region B of the second subject 4 in FIG. 5, and outputs the received information indicating the region A of the first subject 3 and the region B of the second subject 4 to the representative value calculation unit 24.

The data cube 8 is added to the representative value calculation unit 24, and the representative value calculation unit 24 calculates, based on the data cube 8 and the information indicating the region A of the first subject 3 and the region B of the second subject 4, representative values of feature amounts (spectrum data indicating the spectral reflectance or the spectral intensity) in the region A of the first subject 3 and the region B of the second subject 4 for each wavelength constituting the data cube 8. The representative value of the spectrum data of the region A of the first subject 3 can be the average value, the median value, or the most frequent value of the spectrum data of the region A of the first subject 3 in the two-dimensional spectrum data, and similarly, the representative value of the spectrum data of the region B of the second subject 4 can be the average value, the median value, or the most frequent value of the spectrum data of the region B of the second subject 4 in the two-dimensional spectrum data.

The spectral data generation unit 26 inputs the representative value of the spectrum data of the region A of the first subject 3 and the representative value of the spectrum data of the region B of the second subject 4, which are calculated by the representative value calculation unit 24, and generates the first spectral data A(λ) of the first subject 3 and the second spectral data B(λ) of the second subject 4.

The representative value of the spectrum data of the region A of the first subject 3 and the representative value of the spectrum data of the region B of the second subject 4, which are calculated by using the data cube 8, are discrete values for each wavelength which is a layer of the data cube 8. In a case in which the number of the wavelengths which are the layers of the data cube 8 is small, it is preferable that the spectral data generation unit 26 increases the number of data by performing linear interpolation, spline interpolation, or the like on the discrete representative value for each wavelength to acquire, for example, the first spectral data A(λ) and the second spectral data B(λ) shown in FIG. 6. It should be noted that, as the spectral data of each subject, for example, in a case in which the spectral data of the subject (including a part of the subject) is known, the spectral data may be obtained.

A wavelength selection unit 30-1 is a unit that performs wavelength selection processing of selecting a plurality of specific wavelengths from wavelength ranges of the first spectral data A(λ) and the second spectral data B(λ), which are acquired by the data acquisition unit 20 (output from the spectral data generation unit 26).

<Wavelength Selection Processing>

Next, the wavelength selection processing by the wavelength selection unit 30-1 will be described with reference to graphs of the first spectral data A(λ) and the second spectral data B(λ) shown in FIGS. 12 to 16.

FIG. 12 is a graph showing a first example of the first spectral data A(λ) and the second spectral data B(λ).

As shown in the graph of FIG. 12, in the first spectral data A(λ) and the second spectral data B(λ), the spectrum data is monotonically increased as each of the wavelengths is increased, and the wavelength at which the first spectral data A(λ) and the second spectral data B(λ) match each other is not present in a wavelength range of 400 nm to 1000 nm of the present example.

The wavelength selection unit 30-1 selects the plurality of specific wavelengths based on a difference in the feature amount (spectrum data indicating the spectral reflectance or the spectral intensity) between the first spectral data A(λ) and the second spectral data B(λ). As at least one specific wavelength among the plurality of specific wavelengths, a specific wavelength at which the difference (absolute value of the difference) in the spectrum data between the first spectral data A(λ) and the second spectral data B(λ) is largest is selected. In the example shown in FIG. 12, a first wavelength λ1 of an end part on a long wave side of the wavelength range is selected as the specific wavelength at which the difference in the spectrum data is largest.

As for the first wavelength λ1, the difference in the spectrum data between the first spectral data A and the second spectral data B (λ) over the entire wavelength range is obtained, and the wavelength at which the difference in the spectrum data is largest is selected as the first wavelength λ1 (specific wavelength).

In addition, the wavelength selection unit 30-1 selects, as the second specific wavelength, a second wavelength λ2 at which the difference in the spectrum data between the first spectral data A(λ) and the second spectral data B(λ) is smallest, minimum, largest, or maximum in a different wavelength range separated from the first wavelength λ1 selected as described above by a wavelength difference equal to or larger than a predetermined difference.

The reason of the above is that it is preferable that the wavelengths of the first wavelength λ1 and the second wavelength λ2 are separated from each other to some extent. It is preferable that the predetermined difference is equal to or larger than 5 nm. In addition, the predetermined difference may be appropriately settable by the user.

As a result, the wavelength selection unit 30-1 can select the plurality of specific wavelengths (first wavelength λ1 and second wavelength λ2) suitable for the separation between the first subject 3 and the second subject 4.

Now, in a case in which, in the first example shown in FIG. 12, the spectrum data at the first wavelength λ1 and the second wavelength λ2 of the first spectral data A(λ) are denoted by a(λ1) and a(λ2), and the spectrum data at the first wavelength λ1 and the second wavelength λ2 of the second spectral data B(λ) are denoted by b(λ1) and b(λ2), the sensing sensitivity can be calculated by the following expression.

$$Sensing sensitivity = \frac{a ( λ 2 ) - a ( λ 1 )}{a ( λ 2 ) + a ( λ 1 )} - \frac{b ( λ 2 ) - b ( λ 1 )}{b ( λ 2 ) + b ( λ 1 )} \qquad [ Math . 1 ]$$

In all of the following examples as well, it is preferable to evaluate with the sensing sensitivity normalized as shown by the expression of [Math. 1]. In a case of the normalization, the sensing sensitivity is always −1 to 1 in any case, so that relative comparison can be easily performed even in a case in which the spectrum data is changed.

[Table 1] shown below shows one pattern A of the spectrum data.

TABLE 1
[Pattern A]

| | λ1 | λ2 |
|---|---|---|
| a | 10 | 90 |
| b | 30 | 120 |

In a case in which the spectrum data of the pattern A shown in [Table 1] is substituted into the expression of [Math. 1] to obtain the normalized sensing sensitivity, the sensing sensitivity=0.2. On the other hand, in a case in which each of the denominators of the expression of [Math. 1] is set to 1 to obtain the non-normalized sensing sensitivity, the sensing sensitivity=−10.

[Table 2] shown below shows another pattern B of the spectrum data.

TABLE 2
[Pattern B]

| | λ1 | λ2 |
|---|---|---|
| a | 100 | 250 |
| b | 10 | 30 |

In a case in which the spectrum data of the pattern B shown in [Table 2] is substituted into the expression of [Math. 1] to obtain the normalized sensing sensitivity, the sensing sensitivity ≈0.07. On the other hand, in a case in which each of the denominators of the expression of [Math. 1] is set to 1 to obtain the non-normalized sensing sensitivity, the sensing sensitivity=130.

It is preferable that the wavelength selection unit 30-1 selects the plurality of specific wavelengths (in this example, the first wavelength λ1 and the second wavelength λ2) such that the normalized sensing sensitivity is increased.

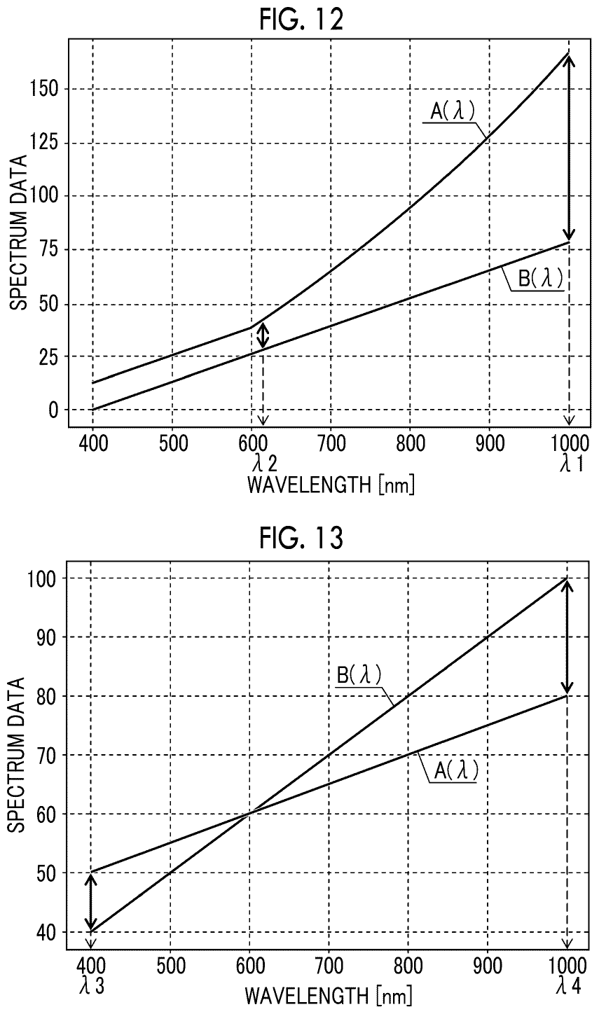

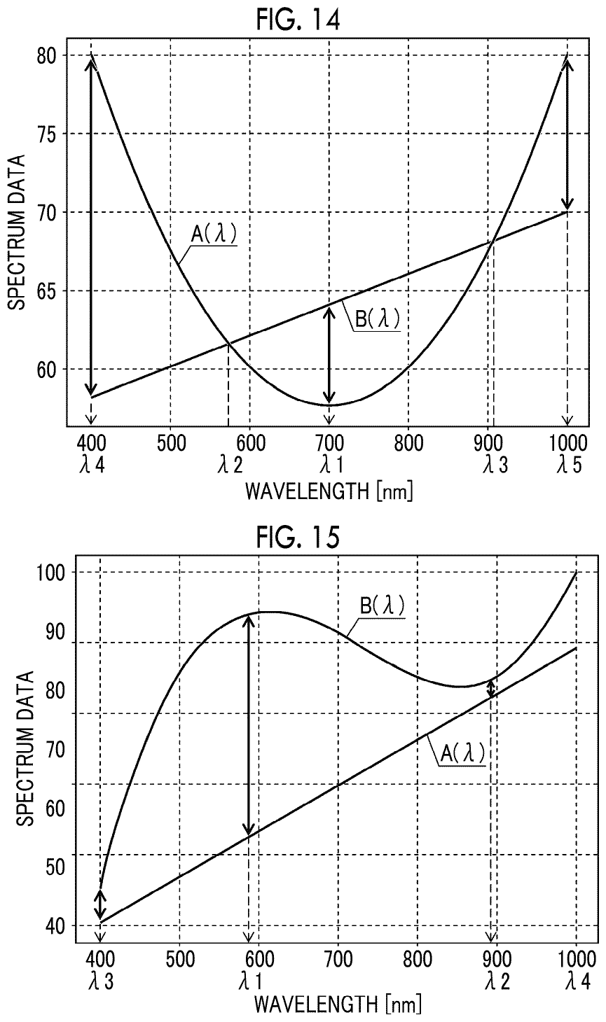

FIG. 13 is a graph showing a second example of the first spectral data A(λ) and the second spectral data B(λ).

As shown in the graph of FIG. 13, in the first spectral data A(λ) and the second spectral data B(λ), the spectrum data is monotonically increased as each of the wavelengths is increased, but the wavelength (reference wavelength: in the present example, 600 nm) at which the first spectral data A(λ) and the second spectral data B(λ) have the spectrum data that match each other is present in a wavelength range of 400 nm to 1000 nm of the present example.

Therefore, in a case of the second example shown in FIG. 13, the wavelength selection unit 30-1 can select a third wavelength λ3 at which the difference in the spectrum data between the first spectral data A(λ) and the second spectral data B(λ) is largest on a short wave side with respect to the reference wavelength and a fourth wavelength λ4 at which the difference in the spectrum data between the first spectral data A(λ) and the second spectral data B(λ) is largest on the long wave side with respect to the reference wavelength, as the specific wavelengths, respectively. In addition, the wavelength selection unit 30-1 can also select, as the specific wavelength, the reference wavelength at which the first spectral data A(λ) and the spectral data of the second spectral data B(λ) have the spectrum data match each other.

FIG. 14 is a graph showing a third example of the first spectral data A(λ) and the second spectral data B(λ).

As shown in the graph of FIG. 14, two intersections (two reference wavelengths at which the spectrum data match each other) are present between the first spectral data A(λ) and the second spectral data B(λ).

In this case, the wavelength selection unit 30-1 can select the first wavelength λ1 (fifth wavelength) at which the difference in the spectrum data between the first spectral data A(λ) and the second spectral data B(λ) is largest between the two reference wavelengths as one of the plurality of specific wavelengths, and can select the second wavelength λ2 and the third wavelength λ3, which are the two reference wavelengths, as the specific wavelengths, respectively. Further, the wavelength selection unit 30-1 can select the fourth wavelength λ4, which is the shortest wavelength in the entire wavelength range, and the fifth wavelength λ5, which is the longest wavelength, as the specific wavelengths, respectively.

In a case in which, in the third example shown in FIG. 14, the spectrum data at the first wavelength λ1, the second wavelength λ2, and the third wavelength λ3 of the first spectral data A(λ) are denoted by a(λ1), a(λ2), and a(λ3), and the spectrum data at the first wavelength λ1, the second wavelength λ2, and the third wavelength λ3 of the second spectral data B(λ) are denoted by b(λ1), b(λ2), and b(λ3), sensing sensitivity can be calculated by the following expression.

$$Sensing sensitivity = \frac{\{ a ( λ 2 ) + a ( λ 3 ) \} / 2 - a ( λ 1 )}{\{ a ( λ 2 ) + a ( λ 3 ) \} / 2 + a ( λ 1 )} - \frac{\{ b ( λ 2 ) + b ( λ 3 ) \} / 2 - b ( λ 1 )}{\{ b ( λ2 ) + b ( λ 3 ) \} / 2 + b ( λ 1 )} \qquad [ Math . 2 ]$$

FIG. 15 is a graph showing a fourth example of the first spectral data A(λ) and the second spectral data B(λ).

As shown in the graph of FIG. 15, in the spectrum data of the first spectral data A(λ) is monotonically increased as each of the wavelengths is increased, and the second spectral data B(λ) does not intersect with the first spectral data A(λ) but has the maximum and minimum. As a result, in the entire wavelength range, the first wavelength λ1 and the second wavelength λ2 at which the difference in the spectrum data between the first spectral data A(λ) and the second spectral data B(λ) is largest (and maximum) and smallest (and minimum) are present.

In a case of the fourth example shown in FIG. 15, the wavelength selection unit 30-1 can select the first wavelength λ1 at which the difference in the spectrum data between the first spectral data A(λ) and the second spectral data B(λ) is largest (maximum) as the specific wavelength, and can select the second wavelength λ2 at which the difference in the spectrum data between the first spectral data A(λ) and the second spectral data B(λ) is smallest (minimum) as the specific wavelength.

Further, the wavelength selection unit 30-1 can select the third wavelength λ3 (in the fourth example shown in FIG. 15, the shortest wavelength in the entire wavelength range) at which the difference in the spectrum data between the first spectral data A(λ) and the second spectral data B(λ) is smallest on the short wave side with respect to the first wavelength λ1 as the specific wavelength.

In a case of the fourth example shown in FIG. 15, in a case in which, across the first wavelength λ1 at which, although the first spectral data A(λ) and the second spectral data B(λ) do not intersect each with other at two points as in a case of the third example shown in FIG. 14, the difference in the spectrum data between the first spectral data A(λ) and the second spectral data B(λ) is largest (maximum), the second wavelength λ2 at which the difference in the spectrum data between the first spectral data A(λ) and the second spectral data B(λ) is smallest (minimum) on the long wave side with respect to the first wavelength λ1 and the third wavelength λ3 at which the difference in the spectrum data between the first spectral data A(λ) and the second spectral data B(λ) is smallest on the short wave side with respect to the first wavelength λ1 are present, the sensing sensitivity can be obtained by applying the expression of [Math. 2] based on the spectrum data of each of the first wavelength λ1, the second wavelength λ2, and the third wavelength λ3 of the first spectral data A(λ) and the second spectral data B(λ).

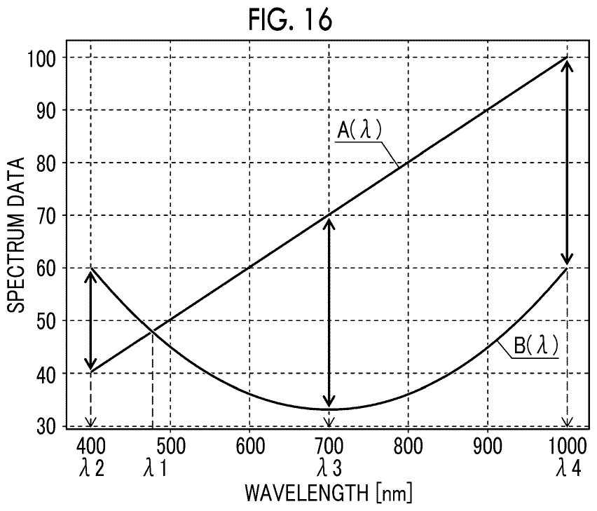

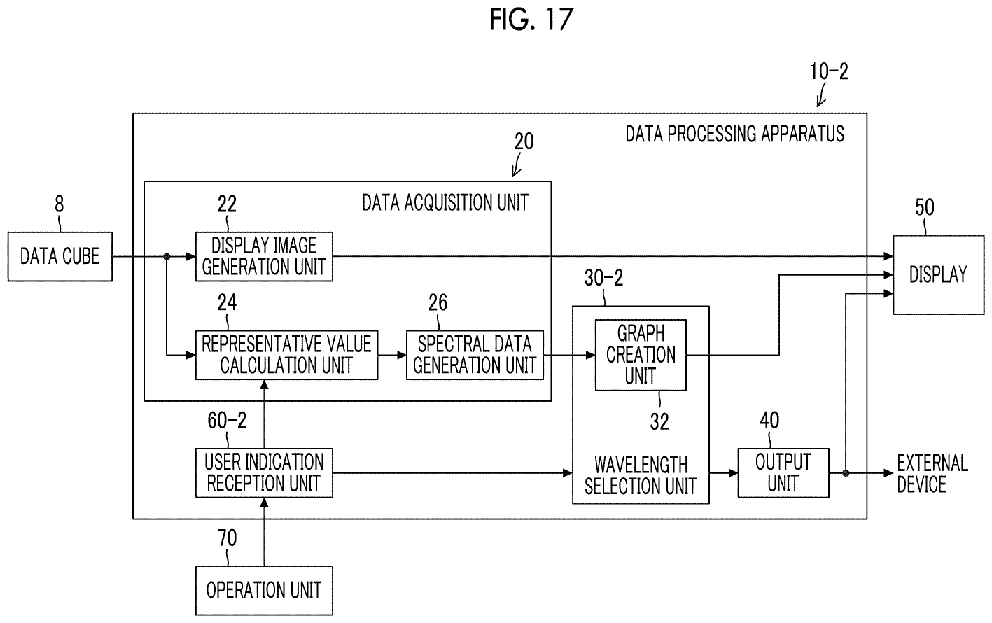

FIG. 16 is a graph showing a fifth example of the first spectral data A(λ) and the second spectral data B(λ).

As shown in the graph of FIG. 16, one intersection (one reference wavelength at which the spectrum data match each other) is present between the first spectral data A(λ) and the second spectral data B(λ).

In this case, the wavelength selection unit 30-1 can select the reference wavelength as the specific wavelength, select the second wavelength λ2 at which the difference in the spectrum data between the first spectral data A(λ) and the second spectral data B(λ) is largest on a short wave side with respect to the reference wavelength and the third wavelength λ3 and the fourth wavelength λ4 at which the difference in the spectrum data between the first spectral data A(λ) and the second spectral data B(λ) is maximum and largest on the long wave side with respect to the reference wavelength, as the specific wavelengths, respectively.

Therefore, in a case of the fifth example shown in FIG. 16, the wavelength selection unit 30-1 can select four wavelengths of the first wavelength λ1, the second wavelength λ2, the third wavelength λ3, and the fourth wavelength λ4 as the specific wavelengths, respectively.

It should be noted that, as the specific wavelengths automatically selected by the wavelength selection unit 30-1, the first spectral data A(λ) and the second spectral data B(λ) of the first example to fifth example shown in FIGS. 12 to 16, but the specific wavelength selected by the wavelength selection unit 30-1 is not limited to the example described above. The plurality of specific wavelengths need only be two or more specific wavelengths suitable for the separation between the first subject 3 and the second subject 4 based on the difference in the feature amount (spectrum data indicating the spectral reflectance or the spectral intensity) between the first spectral data A(λ) of the first subject 3 and the second spectral data B(λ) of the second subject 4.

It is preferable that one of the plurality of specific wavelengths includes a wavelength at which the difference in the spectrum data between the first spectral data A(λ) of the first subject 3 and the second spectral data B(λ) of the second subject 4 is largest. In addition, the wavelength at which the difference in the spectrum data between the first spectral data A(λ) of the first subject 3 and the second spectral data B(λ) of the second subject 4 is maximum or minimum and the wavelength (reference wavelength) at which the difference in the spectrum data therebetween is zero can also be one of the specific wavelengths.

Moreover, in a case in which the first subject 3 and the two second subjects 4A and 4B shown in FIG. 7 are separated from each other, as shown in FIG. 8, two or more specific wavelengths are selected based on the difference in the spectrum data between the first spectral data A(λ) of the first subject 3 and the second spectral data B1(λ) of the second subject 4A, two or more specific wavelengths are selected based on the difference in the spectrum data between the first spectral data A(λ) of the first subject 3 and the second spectral data B2(λ) of the second subject 4B, and two or more specific wavelengths are selected based on the difference in the spectrum data between the second spectral data B1(λ) of the second subject 4A and the second spectral data B2(λ) of the second subject 4B.

That is, in a case in which the first subject 3 shown in FIG. 7 and the two second subjects 4A and 4B are separated from each other, six or more specific wavelengths are selected.

Similarly, in a case in which the first subject 3, the second subject 4, and the third subject 5 shown in FIG. 9 are separated from each other, six or more specific wavelengths are selected.

In a case in which the first subject 3, the second subject 4, and the third subject 5 shown in FIG. 9 are separated from each other, as shown in FIG. 10, two or more specific wavelengths are selected based on the difference in the spectrum data between the first spectral data A(λ) of the first subject 3 and the second spectral data B(λ) of the second subject 4, two or more specific wavelengths are selected based on the difference in the spectrum data between the first spectral data A(λ) of the first subject 3 and the third spectral data C(λ) of the third subject 5, and two or more specific wavelengths are selected based on the difference in the spectrum data between the second spectral data B(λ) of the second subject 4 and the third spectral data C(λ) of the third subject 5.

Returning to FIG. 11, the information indicating the plurality of specific wavelengths selected by the wavelength selection unit 30-1 can be output to the display 50 and an external device.

The display 50 for inputting the information indicating the plurality of specific wavelengths can display the plurality of specific wavelengths and present the plurality of specific wavelengths to the user.

Moreover, as the external device, a recording device that records the plurality of specific wavelengths, a printer that prints out the plurality of specific wavelengths, a design device that designs a bandpass filter or the like based on the plurality of specific wavelengths, and the like can be considered.

### Second Embodiment of Data Processing Apparatus

FIG. 17 is a functional block diagram showing a second embodiment of the data processing apparatus according to the embodiment of the present invention.

It should be noted that, in FIG. 17, the same reference numerals are added to the portions common to the data processing apparatus 10-1 according to the first embodiment shown in FIG. 11, and the detailed description thereof will be omitted.

A data processing apparatus 10-2 according to the second embodiment shown in FIG. 17 is different from the data processing apparatus 10-1 according to the first embodiment in that two or more specific wavelengths are manually selected based on the user indication in the data processing apparatus 10-2, whereas the data processing apparatus 10-1 according to the first embodiment automatically selects two or more specific wavelengths suitable for the separation between the first subject 3 and the second subject 4 which are different types shown in FIG. 1, for example.

Specifically, the data processing apparatus 10-2 according to the second embodiment is different from the data processing apparatus 10-1 according to the first embodiment in that a wavelength selection unit 30-2 and a user indication reception unit 60-2 are provided instead of the wavelength selection unit 30-1 and the user indication reception unit 60-1 of the data processing apparatus 10-1 according to the first embodiment.

The wavelength selection unit 30-2 includes a graph creation unit 32. The graph creation unit 32 creates a graph (first graph) showing the first spectral data A(λ) and a graph (second graph) showing the second spectral data B(λ), as shown in FIGS. 12 to 16, based on the first spectral data A(λ) and the second spectral data B(λ), which are acquired by the data acquisition unit 20. The first graph and the second graph, which show the first spectral data A(λ) and the second spectral data B(λ) are created by the graph creation unit 32, are output to the display 50. As a result, the display 50 displays the first graph and the second graph showing the first spectral data A(λ) and the second spectral data B(λ), respectively, in a discriminable manner (see FIGS. 12 to 16).

Similar to the user indication reception unit 60-1 shown in FIG. 11, the user indication reception unit 60-2 receives the information indicating the region of each subject according to the user indication from the operation unit 70, and receives the information indicating the plurality of wavelengths indicated by the user using the operation unit 70 in relation to the first graph and the second graph which are displayed on the display 50.

For example, in a case in which the first graph showing the first spectral data A(λ) of the first subject 3 and the second graph showing the second spectral data B(λ) of the second subject 4, which are shown in FIGS. 12 to 16, and the like, are displayed on the display 50, the user indicates the plurality of wavelengths suitable for the separation between the first subject 3 and the second subject 4 on the graph. In this case, it is possible to indicate the wavelength at which the difference in the spectrum data between the first spectral data A(λ) and the second spectral data B(λ) is largest, the wavelength at which the difference in the spectrum data therebetween is smallest, the wavelength at which the difference in the spectrum data therebetween is maximum or minimum, or the like.

The wavelength selection unit 30-2 performs processing of receiving the information indicating the plurality of wavelengths received by the user indication reception unit 60-2 as the plurality of specific wavelengths. The information indicating the plurality of specific wavelengths received by the wavelength selection unit 30-2 can be output to the display 50 and the external device in the same manner as the wavelength selection unit 30-1.

[Multispectral Camera]

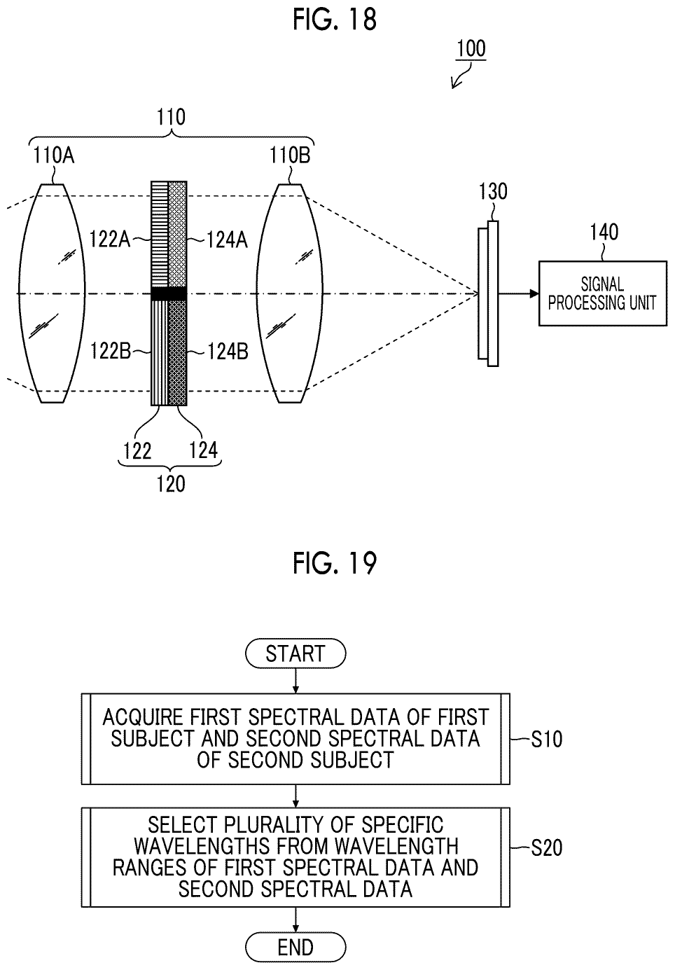

FIG. 18 is a schematic diagram showing an example of the multispectral camera.

A multispectral camera (imaging apparatus) 100 shown in FIG. 18 is composed of an imaging optical system 110 including lenses 110A and 110B and a filter unit 120, an image sensor 130, and a signal processing unit 140, and in particular, a bandpass filter unit 124 provided in the filter unit 120 is composed of, for example, a first bandpass filter (first wavelength selection element) 124A and a second bandpass filter (second wavelength selection element) 124B that transmit light in a wavelength range in which the first wavelength λ1 and the second wavelength λ2 suitable for the separation between the first subject 3 and the second subject 4 shown in FIG. 1 are used as central wavelengths, respectively.

It should be noted that the first wavelength λ1 and the second wavelength λ2 suitable for the separation between the first subject 3 and the second subject 4 the specific wavelengths selected by the data processing apparatus 10-1 according to the first embodiment shown in FIG. 11 or the data processing apparatus 10-2 according to the second embodiment shown in FIG. 17.

It is preferable that the filter unit 120 is composed of a polarizing filter unit 122 and the bandpass filter unit 124, and is disposed at a pupil position of the imaging optical system 110 or in the vicinity of the pupil position.

The polarizing filter unit 122 consists of a first polarizing filter 122A and a second polarizing filter 122B that linearly polarize light transmitted through a first pupil region and a second pupil region of the imaging optical system 110, respectively, and the first polarizing filter 122A and the second polarizing filter 122B have different polarization directions from each other by 90°.

The bandpass filter unit 124 is composed of the first bandpass filter 124A and the second bandpass filter 124B that select the wavelength ranges of the light transmitted through the first pupil region and the second pupil region of the imaging optical system 110, respectively.

Therefore, the light transmitted through the first pupil region of the imaging optical system 110 is linearly polarized by the first polarizing filter 122A, and only the light in the wavelength range including the first wavelength is transmitted by the first bandpass filter 124A. On the other hand, the light transmitted through the second pupil region of the imaging optical system 110 is linearly polarized by the second polarizing filter 122B (linearly polarized in a direction different from that of the first polarizing filter 122A by 90°), and only the light in the wavelength range including the second wavelength is transmitted by the second bandpass filter 124B.

The image sensor 130 is configured such that the first polarizing filter and the second polarizing filter which have different polarization directions from each other by 90° are regularly disposed on a plurality of pixels consisting of photoelectric conversion elements arranged in a two-dimensional manner.

It should be noted that the first polarizing filter 122A and the first polarizing filter of the image sensor 130 have the same polarization direction, and the second polarizing filter 122B and the second polarizing filter of the image sensor 130 have the same polarization direction.

The signal processing unit 140 reads out a pixel signal from the pixel at which the first polarizing filter of the image sensor 130 is disposed, to acquire a first image in a wavelength range whose wavelength is selected by the first bandpass filter 124A, and reads out a pixel signal from the pixel at which the second polarizing filter of the image sensor 130 is disposed, to acquire a second image in a wavelength range whose wavelength is selected by the second bandpass filter 124B.

The first image and the second image acquired by the signal processing unit 140 are images suitable for the separation between the first subject 3 and the second subject 4. By combining the first image and the second image, it is possible to create a composite image in which a dynamic range is expanded and the sensing performance is enhanced.

[Optical Element]

The optical element according to the embodiment of the present invention is an optical element manufactured according to a wavelength combination of two specific wavelengths (first wavelength λ1 and second wavelength λ2) specified by the data processing apparatus 10-1 according to the first embodiment shown in FIG. 11 or the data processing apparatus 10-2 according to the second embodiment shown in FIG. 17.

That is, the optical element corresponds to the bandpass filter unit 124 disposed in the multispectral camera 100 shown in FIG. 18, and includes the first wavelength selection element (first bandpass filter) that transmits the light in the wavelength range including the first wavelength specified by the data processing apparatus and the second wavelength selection element (second bandpass filter) that transmits the light in the wavelength range including the second wavelength specified by the data processing apparatus.

It is preferable that the first bandpass filter and the second bandpass filter use the first wavelength and the second wavelength as the central wavelengths, respectively, and have a bandwidth in which the wavelength ranges of the transmission wavelengths do not overlap with each other.

[Imaging Optical System]

The imaging optical system according to the embodiment of the present invention corresponds to the imaging optical system 110 of the multispectral camera 100 shown in FIG. 18. This imaging optical system is the optical element corresponding to the bandpass filter unit 124, and is configured such that the optical element including the first wavelength selection element (first bandpass filter) that transmits light in the wavelength range including the first wavelength specified by the data processing apparatus and the second wavelength selection element (second bandpass filter) that transmits light in the wavelength range including the second wavelength specified by the data processing apparatus is disposed at the pupil positions of the lenses 110A and 110B or in the vicinity of the pupil positions.

[Imaging Apparatus]

The imaging apparatus according to the embodiment of the present invention corresponds to, for example, the multispectral camera 100 shown in FIG. 18.

The multispectral camera 100 shown in FIG. 18 comprises the imaging optical system (imaging optical system in which the optical element according to the embodiment of the present invention is disposed at the pupil position or in the vicinity of the pupil position) 110 and the image sensor (imaging element) 130 that captures an optical image (first optical image and second optical image) image-formed by the imaging optical system 110.

The first optical image is the optical image transmitted through the first wavelength selection element of the optical element, and the second optical image is the optical image transmitted through the second wavelength selection element of the optical element.

The first optical image and the second optical image are pupil-split by the polarizing filter units 122 (first polarizing filter 122A and second polarizing filter 122B) that function as pupil splitting units, respectively, and the first polarizing filter and the second polarizing filter corresponding to the first polarizing filter 122A and the second polarizing filter 122B on each pixel of the image sensor 130, and are captured by the image sensor 130. As a result, the multispectral camera 100 can simultaneously acquire the first image corresponding to the first optical image and the second image corresponding to the second optical image, which have different wavelength ranges from each other.

It should be noted that the imaging apparatus is not limited to the imaging apparatus having a configuration such as the pupil splitting unit of the multispectral camera 100 shown in FIG. 18, and need only be the imaging apparatus that can capture at least the first optical image transmitted through the first wavelength selection element and the second optical image transmitted through the second wavelength selection element, and can acquire the first image and the second image corresponding to the first optical image and the second optical image.

[Data Processing Method]

The data processing method according to the embodiment of the present invention is a method of selecting the wavelength (specific wavelength) suitable for the separation between the plurality of subjects, and is a method executed by the processor that is a main body of processing of each unit of the data processing apparatuses 10-1 and 10-2 shown in FIG. 11 and FIG. 17.

FIG. 19 is a flowchart showing an embodiment of the data processing method according to the present invention.

In FIG. 19, the processor acquires the first spectral data of the first subject and the second spectral data of the second subject (step S10, data acquisition step).

Subsequently, the processor selects the plurality of specific wavelengths suitable for the separation between the first subject and the second subject from the wavelength ranges of the first spectral data and the second spectral data acquired in step S10 (step S20, wavelength selection step). In a case in which the plurality of specific wavelengths are selected, the plurality of specific wavelengths are selected based on the difference in the feature amount (spectrum data indicating the spectral reflectance or the spectral intensity) between the first spectral data and the second spectral data.

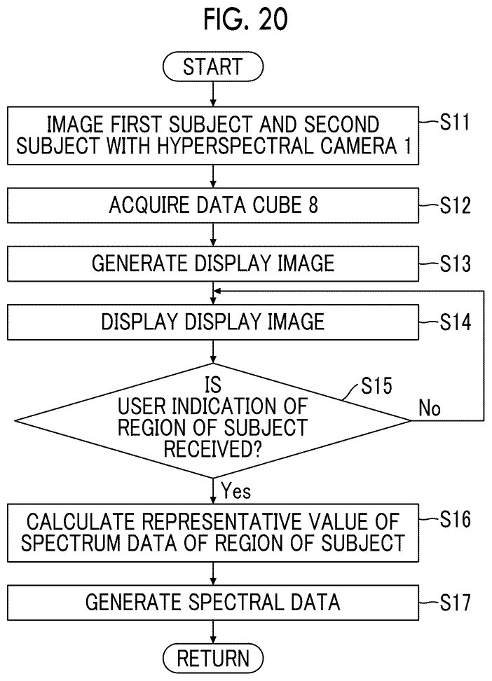

FIG. 20 is a sub-routine showing an embodiment of a processing procedure in step S10 shown in FIG. 19.

As shown in FIG. 20, the user images the first subject and the second subject with the hyperspectral camera 1 (see step S11, FIG. 1, FIGS. 3A, and 3B).

Subsequently, the data cube 8 having the three-dimensional structure in which the two-dimensional spectrum data is arranged for each wavelength to form the layer is acquired (step S12). The data cube 8 acquires the spectral information acquired by the hyperspectral camera 1 by the data processing by the computer in which the data processing software is installed (see FIG. 2 and FIG. 4).

Subsequently, the processor generates the display image (for example, the visible image, such as the pseudo-color image) showing the spectrum data based on the two-dimensional spectrum data included in the data cube 8 (step S13), and display the display image on the display (step S14).

The processor determines whether or not the user indication of the regions of the subjects (first subject and second subject) on the display image displayed on the display is received (step S15). In a case in which the user indication of the region of the subject is not received (in a case of “No”), the processing returns to step S14, and in a case in which the user indication of the region of the subject is received (in a case of “Yes”), the processing proceeds to step S16.

In step S16, the representative value of the spectrum data in the region of the subject is calculated for each wavelength of the data cube 8. The representative value of the spectrum data in the region of the subject can be the average value, the median value, or the most frequent value of the spectrum data in the region of the subject.

Next, the processor generates the spectral data for each subject from the representative value for each wavelength calculated in step S16 (step S17).

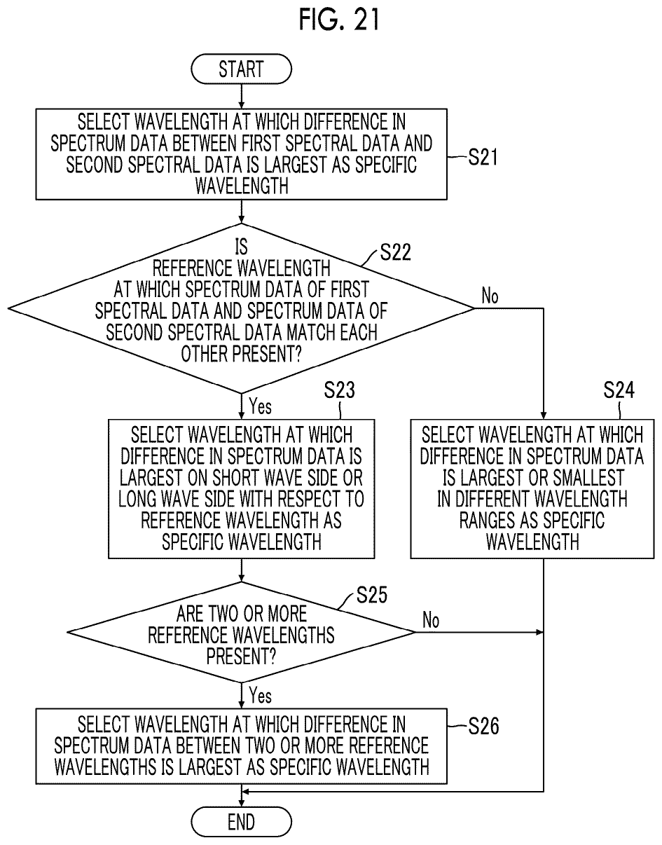

FIG. 21 is a sub-routine showing a first embodiment of a processing procedure in step S20 shown in FIG. 19. In particular, FIG. 21 shows a case in which the plurality of specific wavelengths are automatically selected by the processor.

In FIG. 21, the processor selects the wavelength at which the difference in the spectrum data between the first spectral data of the first subject and the second spectral data of the second subject is largest as one of the plurality of specific wavelengths (step S21).

Next, the processor determines whether or not the reference wavelength at which the spectrum data of the first spectral data and the spectrum data of the second spectral data match (intersect with) each other is present (step S22). In a case in which the processor determines that the reference wavelength is present (in a case of “Yes”), the wavelength at which the difference in the spectrum data is largest on the short wave side and/or the long wave side with respect to the reference wavelength is selected as the specific wavelength (step S23). It should be noted that the reference wavelength can also be selected as the specific wavelength.

On the other hand, in a case in which the processor determines that the reference wavelength is not present (in a case of “No”), the wavelength at which the difference in the spectrum data between the first spectral data and the second spectral data is largest or smallest in a different wavelength range separated from the specific wavelength selected in step S21 by the wavelength difference from the specific wavelength equal to or larger than the predetermined difference is selected as the specific wavelength (step S24).

It should be noted that it is preferable that the predetermined difference is equal to or larger than 5 nm. In addition, the predetermined difference may be appropriately settable by the user. In addition, the wavelength at which the difference in the spectrum data between the first spectral data and the second spectral data is maximum or minimum can also be selected as the specific wavelength.

Subsequently, the processor determines whether or not two or more reference wavelengths at which the spectrum data of the first spectral data and the spectrum data of the second spectral data match (intersect with) each other are present (step S25). In a case in which it is determined that two or more reference wavelengths are present (in a case of “Yes”), a wavelength at which the difference in the spectrum data between the two or more reference wavelengths in the spectral data is largest is selected as the specific wavelength (step S26).

As described above, the processor can automatically select the plurality of specific wavelengths suitable for the separation between the plurality of subjects.

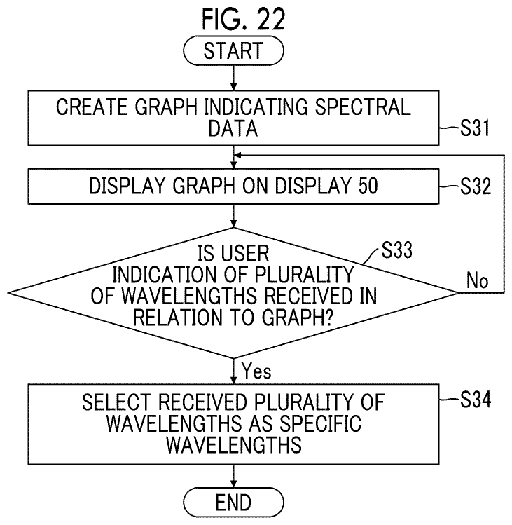

FIG. 22 is a sub-routine showing a second embodiment of the processing procedure in step S20 shown in FIG. 19. FIG. 22 shows, in particular, a case in which the plurality of specific wavelengths are selected according to the user indication.

In FIG. 22, the processor creates the graphs (first graph and second graph) showing these spectral data based on the first spectral data of the first subject and the second spectral data of the second subject (step S31).

Subsequently, the processor displays the first graph and the second graph created in step S31 on the display 50 in a discriminable manner (step S32).

The processor determines whether or not the user indication of the plurality of wavelengths is received in relation to the first graph and the second graph which are displayed on the display 50 (step S33). While viewing the first graph and the second graph which are displayed on the display 50, the user can visually check the wavelength at which the difference in the spectrum data is largest and the like, and can indicate the wavelength with the pointing device or the like.

The processor can receive the plurality of wavelengths indicated by the user, and can select the received plurality of wavelengths as the specific wavelengths in a case in which the processor determines that the user indication of the plurality of wavelengths is received (in a case of “Yes”) (step S34).

[Others]

In the present embodiment, for example, the hardware structure of the processing units that execute various processing of the processor constituting the data processing apparatus is the following various processors. The various processors include a central processing unit (CPU), which is a general-purpose processor that executes software (program) and functions as the various processing units, a programmable logic device (PLD), which is a processor of which a circuit configuration can be changed after manufacture, such as a field programmable gate array (FPGA), and a dedicated electric circuit, which is a processor having a circuit configuration that is designed for exclusive use in order to execute specific processing, such as an application specific integrated circuit (ASIC).

One processing unit may be configured by one of these various processors, or may be configured by two or more same type or different types of processors (for example, a plurality of FPGAs or a combination of the CPU and the FPGA). Moreover, a plurality of processing units may be configured by one processor. As a first example the configuration of the plurality of processing units by one processor, there is a form in which one processor is configured by a combination of one or more CPUs and software, and this processor functions as the plurality of processing units, as represented by a computer, such as a client or a server. Second, there is a form in which a processor, which realizes the functions of the entire system including the plurality of processing units with one integrated circuit (IC) chip, is used, as represented by a system on chip (SoC) or the like. As described above, various processing units are configured by one or more of the various processors described above, as the hardware structure.

Further, the hardware structure of these various processors is, more specifically, an electric circuit (circuitry) in which circuit elements, such as semiconductor elements, are combined.

In addition, the present invention includes the data processing program causing the computer to function as the data processing apparatus according to the embodiment of the present invention by being installed in the computer, and a non-volatile storage medium in which the data processing program is recorded.

Further, the present invention is not limited to the embodiments described above, and it is needless to say that the modifications can be made without departing from the spirit of the present invention.

### EXPLANATION OF REFERENCES

1: hyperspectral camera
2: light source
3: first subject
4, 4A, 4B: second subject
5: third subject
6, 6A, 6B: spectral information
7: computer
8, 8A, 8B: data cube
10-1, 10-2: data processing apparatus
20: data acquisition unit
20-1: wavelength selection unit
22: display image generation unit
24: representative value calculation unit
26: spectral data generation unit
30-1, 30-2: wavelength selection unit
32: graph creation unit
40: output unit
50: display
60-1, 60-2: user indication reception unit
70: operation unit
100: multispectral camera
110: imaging optical system
110A, 110B: lens
120: filter unit
122: polarizing filter unit
122A: first polarizing filter
122B: second polarizing filter
124: bandpass filter unit
124A: first bandpass filter
124B: second bandpass filter
130: image sensor
140: signal processing unit
S10 to S33: step

What is claimed is:

1. A data processing apparatus comprising:
a processor,
wherein the processor performs
data acquisition processing of acquiring first spectral data of a first subject and second spectral data of a second subject, and
wavelength selection processing of selecting a plurality of specific wavelengths from wavelength ranges of the acquired first spectral data and second spectral data, and
in the wavelength selection processing, the plurality of specific wavelengths are selected based on a sensing sensitivity which is a normalized difference in a feature amount between the first spectral data and the second spectral data.

2. The data processing apparatus according to claim 1,
wherein the feature amount is spectral reflectance or spectral intensity.

3. The data processing apparatus according to claim 1,
wherein at least one specific wavelength among the plurality of specific wavelengths is a wavelength at which the difference in the feature amount is largest.

4. The data processing apparatus according to claim 1,
wherein, in the data acquisition processing, data is acquired from a device that acquires two-dimensional spectrum data of wavelengths more than the selected plurality of specific wavelengths.

5. The data processing apparatus according to claim 4,
wherein the processor performs display processing of displaying a visible image showing the spectrum data on a display based on the spectrum data.

6. The data processing apparatus according to claim 5,
wherein, in the data acquisition processing, a first region of the first subject and a second region of the second subject are specified on the display based on a user indication, and the first spectral data and the second spectral data in the first region and the second region are acquired.

7. The data processing apparatus according to claim 6,
wherein, in the data acquisition processing, representative values of the feature amounts in the first region and the second region are calculated to acquire the first spectral data and the second spectral data.

8. The data processing apparatus according to claim 7,
wherein the representative value is an average value, a median value, or a most frequent value.

9. The data processing apparatus according to claim 1,
wherein, in the wavelength selection processing, a first wavelength at which the difference in the feature amount between the first spectral data and the second spectral data is largest, and a second wavelength at which the difference in the feature amount between the first spectral data and the second spectral data is largest or maximum in a different wavelength range separated from the first wavelength by a wavelength difference equal to or larger than a predetermined difference are selected as the specific wavelengths.

10. The data processing apparatus according to claim 9,
wherein the predetermined difference is equal to or larger than 5 nm.

11. The data processing apparatus according to claim 1,
wherein, in the wavelength selection processing, in a case in which a reference wavelength at which the feature amounts of the acquired first spectral data and second spectral data match each other is present, a third wavelength at which the difference in the feature amount between the first spectral data and the second spectral data is largest on a short wave side with respect to the reference wavelength, and a fourth wavelength at which the difference in the feature amount between the first spectral data and the second spectral data is largest on a long wave side with respect to the reference wavelength are selected as the specific wavelengths.

12. The data processing apparatus according to claim 1,
wherein, in the wavelength selection processing, in a case in which two or more reference wavelengths at which the feature amounts of the acquired first spectral data and second spectral data match each other are present, a fifth wavelength at which the difference in the feature amount between the first spectral data and the second spectral data is largest between the two or more reference wavelengths is selected as one of the plurality of specific wavelengths.

13. The data processing apparatus according to claim 1,
wherein, in the wavelength selection step, the sensing sensitivity is calculated by the following expression
$$Sensing sensitivity = \frac{a ( λ 2 ) - a ( λ 1 )}{a ( λ 2 ) + a ( λ 1 )} - \frac{b ( λ 2 ) - b ( λ 1 )}{b ( λ 2 ) + b ( λ 1 )}$$
in which, the plurality of wavelengths are a first wavelength λ1 and a second wavelength λ2,
the spectrum data at the first wavelength λ1 and the second wavelength λ2 of the first spectral data A(λ) are denoted by a(λ1) and a(λ2), and
the spectrum data at the first wavelength λ1 and the second wavelength λ2 of the second spectral data B(λ) are denoted by b(λ1) and b(λ2).

14. The data processing apparatus according to claim 1,
wherein, in the wavelength selection step, the sensing sensitivity is calculated by the following expression
$$Sensing sensitivity = \frac{\{ a ( λ 2 ) + a ( λ 3 ) \} / 2 - a ( λ 1 )}{\{ a ( λ 2 ) + a ( λ 3 ) \} / 2 + a ( λ 1 )} - \frac{\{ b ( λ 2 ) + b ( λ 3 ) \} / 2 - b ( λ 1 )}{\{ b ( λ2 ) + b ( λ 3 ) \} / 2 + b ( λ 1 )}$$
in which, the plurality of wavelengths are a first wavelength λ1, a second wavelength λ2 and a third wavelength λ3,
the spectrum data at the first wavelength λ1, the second wavelength λ2 and the third wavelength λ3 of the first spectral data A(λ) are denoted by a(λ1), a(λ2) and a(λ3), and
the spectrum data at the first wavelength λ1, the second wavelength λ2 and the third wavelength λ3 of the second spectral data B(λ) are denoted by b(λ1), b(λ2) and b(λ3).

15. A data processing method to be executed a processor, comprising:
a data acquisition step of acquiring first spectral data of a first subject and second spectral data of a second subject; and
a wavelength selection step of selecting a plurality of specific wavelengths from wavelength ranges of the acquired first spectral data and second spectral data, in which the plurality of specific wavelengths are selected based on a difference in a feature amount between the first spectral data and the second spectral data,
wherein, in the wavelength selection processing, the plurality of specific wavelengths are selected based on a sensing sensitivity which is a normalized difference in a feature amount between the first spectral data and the second spectral data.

16. The data processing method according to claim 15,
wherein the feature amount is spectral reflectance or spectral intensity.

17. The data processing method according to claim 15,
wherein the at least one specific wavelength among the plurality of specific wavelengths is a wavelength at which the difference in the feature amount is largest.

18. The data processing method according to claim 15,
wherein, in the data acquisition step, data is acquired from a device that acquires spectrum data of wavelengths more than the selected plurality of specific wavelengths.

19. The data processing method according to claim 18, further comprising:
a step of displaying a visible image showing the spectrum data on a display based on the spectrum data.

20. The data processing method according to claim 19,
wherein, in the data acquisition step, a first region of the first subject and a second region of the second subject are specified on the display based on a user indication, and the first spectral data and the second spectral data in the first region and the second region are acquired.

21. The data processing method according to claim 20,
wherein, in the data acquisition step, representative values of the feature amounts in the first region and the second region are calculated to acquire the first spectral data and the second spectral data.

22. The data processing method according to claim 21,
wherein the representative value is an average value, a median value, or a most frequent value.

23. The data processing method according to claim 15,
wherein, in the wavelength selection step, a first wavelength at which the difference in the feature amount between the first spectral data and the second spectral data is largest, and a second wavelength at which the difference in the feature amount between the first spectral data and the second spectral data is largest or maximum in a different wavelength range separated from the first wavelength by a wavelength difference equal to or larger than a predetermined difference are selected as the specific wavelengths, respectively.

24. The data processing method according to claim 23,
wherein the predetermined difference is equal to or larger than 5 nm.

25. The data processing method according to claim 15,
wherein, in the wavelength selection step, in a case in which a reference wavelength at which the feature amounts of the acquired first spectral data and second spectral data match each other is present, a third wavelength at which the difference in the feature amount between the first spectral data and the second spectral data is largest on a short wave side with respect to the reference wavelength, and a fourth wavelength at which the difference in the feature amount between the first spectral data and the second spectral data is largest on a long wave side with respect to the reference wavelength are selected as the specific wavelengths, respectively.

26. The data processing method according to claim 15,
wherein, in the wavelength selection step, in a case in which two or more reference wavelengths at which the feature amounts of the acquired first spectral data and second spectral data match each other are present, a fifth wavelength at which the difference in the feature amount between the first spectral data and the second spectral data is largest between the two or more reference wavelengths is selected as one of the plurality of specific wavelengths.

27. A non-transitory, computer-readable tangible recording medium on which a program for causing, when read by a computer, the computer to execute the data processing method according to claim 15 is recorded.
